(19) United States
(12) Patent Application Publication
(10) Pub. No.: US 2014/0125455 A1
(43) Pub. Date: May 8, 2014

(54) SYSTEMS AND ALGORITHMS FOR CLASSIFICATION OF USER BASED ON THEIR PERSONAL FEATURES

(71) Applicant: Memphis Technologies, Inc., Boca Raton, FL (US)

(72) Inventors: Yaron Menczel, Mevasseret Zion (IL); Yair Shachar, Ramat Gan (IL)

(73) Assignee: Memphis Technologies, Inc., Boca Raton, FL (US)

(21) Appl. No.: 14/154,594

(22) Filed: Jan. 14, 2014

Related U.S. Application Data
(63) Continuation-in-part of application No. 13/974,669, filed on Aug. 23, 2013.
Application No. 13/974,669 is a continuation of application No. 13/353,443, filed on Jan. 19, 2012.
Application No. 13/353,443 is a continuation of application No. 11/216,022, filed on Sep. 1, 2005, now Pat. No. 8,122,259.

(51) Int. Cl. G06F 21/31

(52) U.S. Cl. CPC G06F 21/31
USPC 340/5.81

(57) ABSTRACT

A system and algorithms to authenticate a person where a system only has some standard personal text data about the person, and cannot have a real biometric template obtained using an enrollment procedure. The authentication allows access to restricted resources by the person. This method is especially useful when it is used as an auxiliary authentication service with other methods such as password or Callback that dramatically lower the chances for an imposter.

### RELATED APPLICATIONS

This is a continuation in part of U.S. patent application Ser. No. 13/974,669 filed Aug. 23, 2013, which is a continuation of U.S. patent application Ser. No. 13/352,443, filed Jan. 18, 2012 now U.S. Pat. No. 8,549,319 issued Oct. 1, 2013 which is a continuation of U.S. patent application Ser. No. 11/216,022, filed Sep. 1, 2005, now U.S. Pat. No. 8,122,259 issued Feb. 21, 2012, which are hereby incorporated by reference in its entirety for all purposes.

### FIELD OF THE INVENTION

The present invention relates to Computer Telephony Integration (CTI); specifically, to systems and algorithms which need to Authenticate a person before allowing him to use a certain device or gain access to a restricted area.

### BACKGROUND OF THE INVENTION

In a variety of applications there is a need to authenticate the identity of a user before he can use a certain service, or gain access to a restricted data or a physical location. A common approach to address this need is by using computerized biometric verification techniques. According to this two steps approach, the first step is known as “enrollment” where an identifiable and preferably unique set of biometric characteristics of a person are being extracted to generate a “template” aimed to function as a biometric signature of that person. The template is then being stored in a centralized data base. In the second step (usually at a distinct occasion and can be repeated for many times), the same biometric characteristics are being extracted to generate yet another template which is compared to the first template. If there is a high degree of match between the parameters in the two templates beyond a certain threshold, the person is authenticated in the biometrical sense. In the known art, there are variety of methods to implement this approach which are based on different biometrical attributes (also known as modalities) such as human face, iris, voice, finger print, hand geometry and others. It is also possible to combine several of these modalities to create a multimodal solution e.g. using both face and finger print parameters.

While the biometric approach for authentication is gaining an increasing popularity, there are some barriers for a massive use of it in many applications. Two of these barriers are:
1) The need for the “enrollment” step, where in this step the user identity is needed to be determined by his/her physical attendance at some specific location, where he/her can show an identifier (e.g. an identity card). Then, one needs to go through the enrollment process which can be a time consuming and expensive process.
2) Storing user's biometric data in some organization's centralized database generates a real privacy problem, and is even currently illegal in some places. In addition, in some cases it is prohibitive to use persistent data. An alternative approach to central storing is to store the information on a personal “smart card”, which is being kept within the user possession. While this alternative reduces the extent privacy problem it is cumbersome, not practical and too expensive for many applications.

In many cases, biometric verification is often used only as a complementary mean to other simpler authentication methods like the use of password. Many web sites use only password to assure that the person logged in is indeed the legitimate person and not an imposer. It has been demonstrated that adding a biometric check in addition to password, reduces abuses significantly.

### SUMMARY OF THE INVENTION

The current invention discloses a new approach for authentication of users which are seeking to get access to restricted services, contents or physical locations. It utilizes stateless biometric methods, which do not include the process of enrollment and storing the sensitive biometric user data in a database or any other storing device (centralized or personalized). Instead, only standard (e.g. date of birth, address, gender, birthplace, social security number) are being stored. When a person is asking for an access to the restricted resource, biometric data of the person is being extracted “on the fly” as part of its interaction with the system. That biometric data is compared to the actual subset of standard personal details that are known about the person. According to this comparison, the system can determine whether or not to exclude him/her from access to the restricted resource.

Some embodiments of the present invention depict classification of user attributes into groups. The group classification can be used as part of the authentication procedure by comparing the classification data to the personal details record or directly as a decision factor.

Some embodiments of the present invention depict an auto bill pay system for example via a phone. As part of the user authentication procedure he/she is requested to provide one or several voice responses to an Interactive Voice Response (IVR) system. The voice of this person is being analyzed to biometrically extract and estimate attributes such as person age, gender, ethnical origin, pronunciation, emotional state (e.g. what is the voice credibility level as analyzed by ones voice) and alcoholic blood level. Some attributes (e.g. gender, age, ethnical origin) may be compared against the personal details data record to check for a correspondence. Additionally, some of these attributes (e.g. age, emotional stage, and alcoholic blood level) can be used directly as a decision factor. For example, a young child or a person recognized by the system to have high alcoholic blood level and/or low voice credibility level may not be granted with an access to a restricted auto bill pay system.

Optionally, the above embodiments may generate a biometric voice template (or templates) for the attending user. But instead of authenticating the person by comparing the voice template to a pre stored template (as commonly being done in the current art), this template will be compared vis-à-vis to a “black list” of templates representing, for example, known criminals or those who are suspected to previously be involved in improper usage of the system.

Some embodiments of the present invention may be assisted by other means to raise its confidence level. For example, the system may initiate a phone call to a person (Call Back scenario), to significantly reduce the probability for an imposer. It still may be the case that someone else answered the call, but that usually is done innocently, and the methods disclosed in this invention may recognize these latter cases with a high probability.

Some embodiment of the present invention may use speech recognition on a spoken speech segment of the user. For example, the user might be asked to provide information items such as (but not limited to) birth date, social security number, maiden name of his mother. That speech segment will be sent to a speech recognition element to translate it to a data record and then to compare it to existing data record or records.

Some embodiment of the present invention may use the recorded speech as digital signature to provide either directly or indirectly a recorded copy of the transaction and/or a proof that a transaction was authorized by the user.

Some embodiments of the present invention depict a system controlling access to restricted content, for example adult entertainment on the World Wide Web or TV. As part of the access control procedure, the user is requested to provide one or several voice responses to an Interactive Voice Response (IVR) system. As in the previous embodiment, the voice sample or samples are analyzed to biometrically extract and estimate attributes, and used in a procedure similar to what have been described. For example, it can be used to block child access to adult entertainment material if the age value as recognized by his voice, is smaller than a certain threshold.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well-known features may be omitted or simplified in order not to obscure the present invention The present invention will be understood and appreciated more fully from the following detailed description taken in conjunction with the drawings in which:

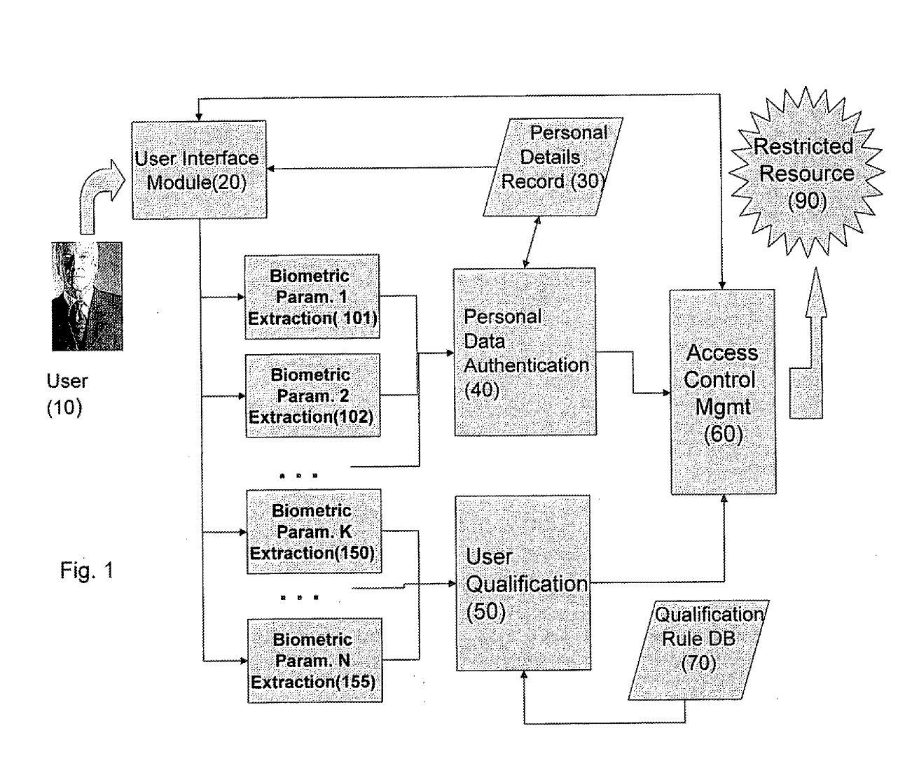

FIG. 1 depicts a general scheme of an authentication method according to some embodiments of the present invention.

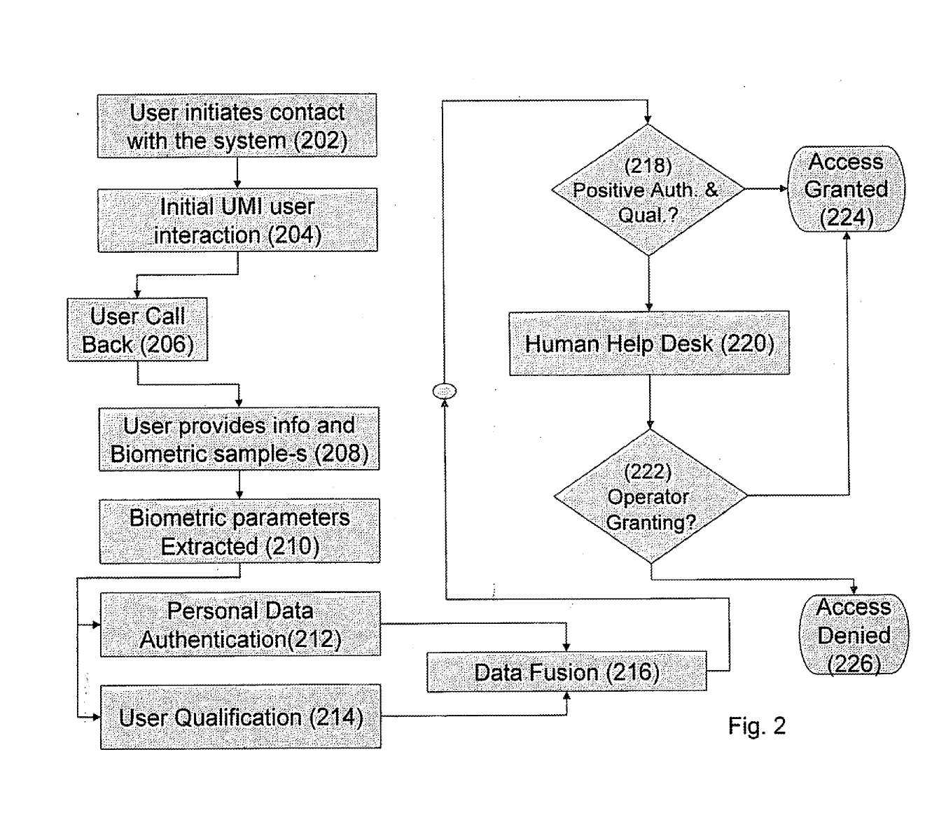

FIG. 2 depicts an auto bill pay system according to an embodiment of the of the present invention;

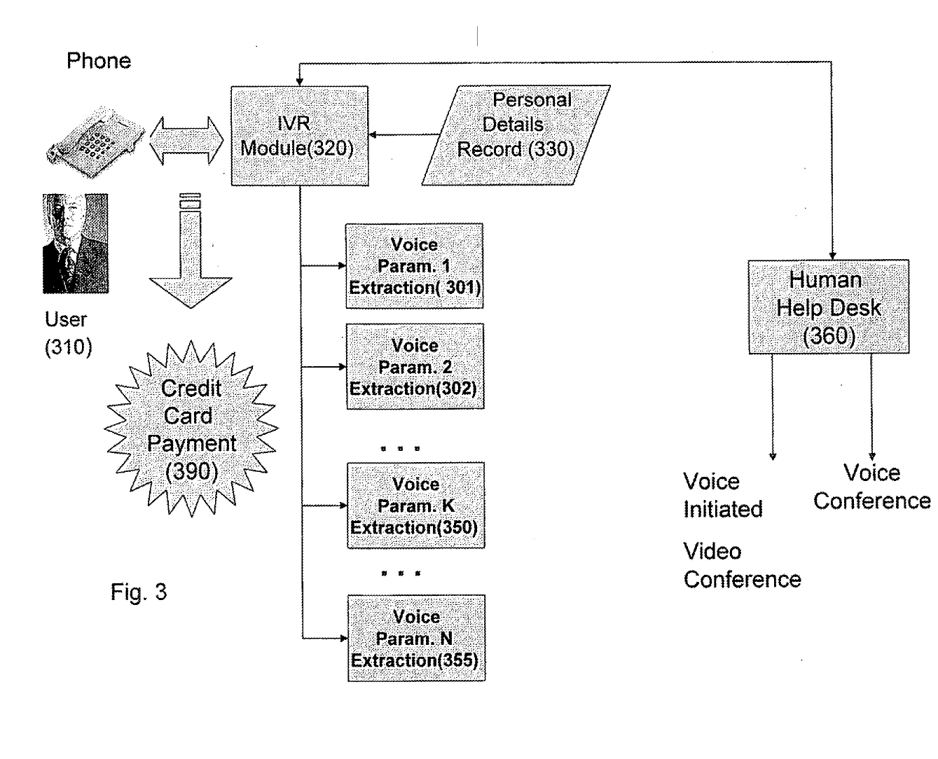

FIG. 3 depicts a content access control system according to an embodiment of the present invention;

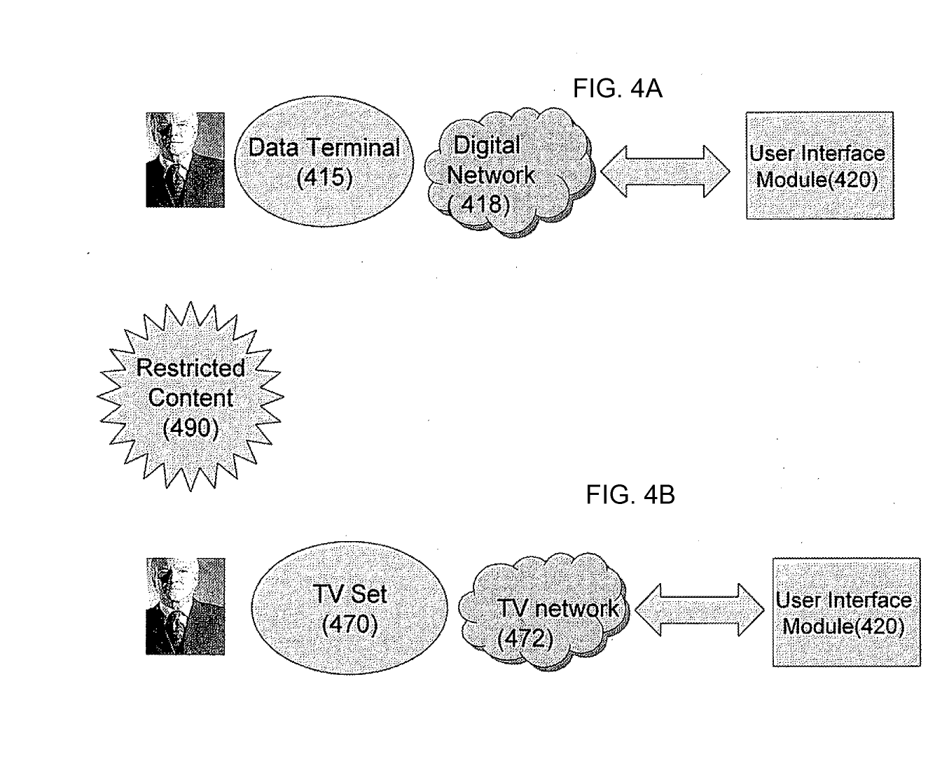

FIG. 4a is a flow chart that depicts a method for content access control according to an embodiment of the present invention;

FIG. 4b is a flow chart that depicts a method for content access control according to an embodiment of the present invention;

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Attention is made now to FIG. 1, which depicts a user (10) asking to get access to a restricted resource or resources (90). A computerized User Interface Module—UIM (20) is used to interact with the user, give him/her some instructions and information, prompting the user to provide its intended request, some of his/her personal details and other information item including (but not limited to) authentication data like a password. The supplied user data can be tested vis-à-vis the personal data record of the user, as stored in the system database.

One example of such a user interface module is known as IVR (Interactive Voice Response) subsystem which is possibly part of the UIM-20. Other configurations of UIM may be used as well. In addition and as part of this invention, the UIM receives a biometric sample or samples of the user. This can be accomplished either by an explicit request from the user to provide it, or implicitly as part of the user interaction process. The biometric sample or samples may include (but not limited to) items like voice sample(s), person image(s) or video clips, key stroke pattern and finger print data.

A plurality of N (N>=1) biometric extraction modules (101-155) may then be used to extract corresponding biometric-based parameters from the user's biometric samples. For example, a voice sample of a user can be used to extract parameters such as (but not limited to):

a) Age of the user.

### b) Gender

c) Ethnical or geographical origin

### d) Pronunciation

e) Emotional state of the user

### f) Credibility

g) Level of Alcohol or other materials in the user's blood.

A typical outcome of each biometric extraction module is a probability function, which defines the estimated probability of the corresponding parameter to match to certain values or a set of ranges of values of the investigated biometric identifier. For example, a possible result of an Age extractor, investigating the age-identifier for a specific sample is given in the following table 1-1:

| Group | Age value 1 | Age value 2 | Probability |
|---|---|---|---|
| 1 | 0 | 18 | 0.1 |
| 2 | 18 | 40 | 0.3 |
| 3 | 40 | 60 | 0.5 |
| 4 | 60 | 120 | 0.1 |

The column <Age value 1> defines the lowest value of each age group. The column <Age value 2> defines the lowest value of each age group which is above the maximal age of that group. The probability column defines the estimated probability of the user's age to belong to each group as generated by the biometric extraction module algorithm based on the sample.

Each biometric extraction module result, may be used as an input to a Personal Data Authentication block (40 and/or to a User Qualification block (50)). For the purpose of a clear illustration of the interaction between the different modules in FIG. 1, it is shown in this figure that each biometric extraction module is directed either to Personal Data Authentication block (40) or to a User Qualification block (50). Modules (101, 102 . . . ) are used as an input to the first block and modules (150, 151 . . . ) to the latter. The reader should note that the output of the same extractor module may serve as an input to both blocks. In this case, one may think on such a module as duplicated into two modules one in the group of modules numbered as (101, 102 . . . ) and the other reproduction in the group numbered as (150, 151 . . . ).

At the Personal Data Authentication block (40) a valuation process may be commenced, based on the outputs of modules (100, 101 . . . ), for a match between known user parameters which are given in a data record such as the Personal Details Record (30) and results of the biometric extraction module(s). Preferably, as a result of this valuation process, a score vector is generated. Also according to preferred embodiments of this invention, the Personal Details Record (30) does not contain biometric template but rather just data items.

For example, if the actual user age appears in the Personal Details Record (30), one possible valuation process is a comparison of this age value versus the output of a corresponding age biometric extraction module as shown in table 1-1. Other types of a valuation process and/or biometric parameters may take place as well, and forms of result, other than a score vector may be generated.

In addition, block (40) may contain a fusion module, in case where this block receives results from a plurality of biometric extraction modules (101, 102 . . . ). A fusion module preferably generates a single result vector as a function of the input parameter space. There are many fusion methods in the existing art which are known to the proficient reader.

At the User Qualification block (50) a valuation process may be commenced, based on the outputs of modules (150, 151 . . . ), for computing the qualification level that that particular user may be able to access the restricted resource or resources (90). At this block the qualification level is not calculated based on a match with the user' Personal Details Record (30), but rather directly as a result of the extracted biometric parameters. Preferably, as a result of this valuation process, a score vector is generated. For example, an age value output of a corresponding age biometric extraction module may be used as a criterion for accessing a restricted resource involving payments and/or access to an adult entertainment material. For values as shown in table 1-1, the valuation process may give high qualification score to the age parameter since there is a high probability that the user is over 18 years old. Another possible parameter is the estimation of the user alcoholic level in blood extracted out of his/here voice tract. High estimated blood alcohol level may generate a low qualification score. The set of rules determining the qualification valuation process may reside in a predefined Qualification Rule database (70). Other types of a valuation process and/or biometric parameters may take place as well, and forms of result, other than a score vector may be generated.

In a similar manner to the above description for block (40), block (50) may also contain a fusion module, in case where this block receives results from a plurality of biometric extraction modules (151, 152 . . . ).

In other embodiments, either the Personal Data Authentication block (40) or the User Qualification block (50) may be omitted, or being activated each only on a sub group of the users. It is also possible that the list of active modules (100, 101 . . . ) and/or modules (150, 151 . . . ) will be determined per user or per a group of users.

Further according to a preferred embodiment of this invention. The Access Management block (70), receives the valuation results of blocks (40) and (50). Based on these results and possibly on the standard authentication process as described herein above, the user is either being granted access to the restricted resources, denied access to the resource, or being transferred to a human help desk for additional examination (not shown in FIG. 1). The UIM (20) is used to handle the interface with the user for these different cases.

FIG. 2 depicts a flow chart of a preferred embodiment of the current invention. In one case the user initiates the contact with the system (202), via the UIM (20) for an initial interaction with (204). The system may initiate a “call back” or a “contact back” procedure. It is well known from the state of the art in the field that call back is a useful way to limit attempts to steal the identity of valid users by imposters. In an alternative case, the system may initiate the contact with the user at (202). A standard authentication process as described herein above, may be employed. As part of this procedure or as a separate process, the user provides a biometric sample or samples (208). Some examples of possible types of biometric sample(s) are user's voice tract, image of the user face, iris, finger print, hand geometry and ultra sound image.

As the sample or samples are provided, the corresponding biometric parameter(s) are extracted (210). Following the parameter extractions the process of Personal Data Authentication (212) and/or User Qualification (214) are being performed in the described above manner.

Then, optionally a Data Fusion (216) process may take place in order to generate a unified result or a score vector. In the cases where both Personal Data Authentication (212) and User Qualification (214) are active, the Data Fusion (216) process may comprise two steps, where first the outputs of (212) and (214) are fused separately and then a unified result or a score vector is generated out of the two fused outputs. As part of the fusion process, some cross section statistical processes might be carried out. For example, a process might compare the biometrically extracted ethnical origin of the user, to the ethnical distribution of the user residence location, according to a census, and generate a match score.

If the result of the above process provides a positive <authentication and/or qualification> of the user, an access in granted (224) to the restricted resource or resources. Otherwise, the user is either rejected or being transferred to a human operator in a helpdesk as shown in the FIG. 220). The human operator might be randomly selected out of the list of available operators, or selected according to some criteria. For example, operator having a previous experience with the specific user, or having the same age group and/or gender and/or ethnical origin as the user, proximity of the geographic residence locations regarding the user and the operator or other criteria. The operator may pose farther questions to the user and decide (222) to either grant access to the user (224) or deny the access (226) to the restricted resource or resources

FIG. 2 depicts an example of an application based on the current invention, a credit card or an auto bill payment system. In this example application, the user interacts with the system via a phone. An Interactive Voice Response module—IVR (320) instantiates User Interface Module—UIM (20) of FIG. 1. The restricted resource in this case is a credit card payment (390) and the user (310) is a one wishing to perform this financial transaction. The Personal Details Record in this case, is the record that the credit card firm maintains in its database for that user (330).

The mechanism for this application is similar to what have been described in FIG. 1. An additional option which is shown here is the ability of an operator on the help desk (360) to hold a voice initiated video and/or data collaboration session with the user. According to this scheme, first a voice conference is being held between the user and the operator, which by a click on a phone button may initiate a full real time collaboration session between the user, the operator and optionally additional parties. This mechanism is described in full by the U.S. Pat. No. 6,831,675, and later application Ser. No. 10/801,112.

FIG. 4A discloses yet another example of application based on the current invention. In this example, the user is seeking access to a Restricted Content (490). Such content might be a pay per view, adult entertainment or any other type of restricted content in the form of video, voice, images data or any combination of these forms. The user is interacting with the system via a data terminal (415), a digital network (e.g. the internet), and a User Interface Module (420) which may have several modes of operation, for example a web server communicating with user via an HTTP protocol. One possible example of the usage of biometric extraction parameters in this case, is the extraction of the user age and using this parameter as part of the User Qualification Block to determine access rights to an adult entertainment material.

FIG. 4B discloses an application which is similar to that of FIG. 4A. In this case a TV Set (470) is used as the interaction port for the user, and the TV network (472) in any form (analog, digital) as the connection carrying infrastructure between the user and the User Interface Module (420).

In another embodiment the application uses the known user parameters which are given in a data record such as the Personal Details Record (30) to qualify the user in order to determine its qualification to belong to a specific class and/or be permitted to be eligible for certain services. At the User Qualification block (50) a valuation process may be commenced, based on the Personal Detail Record (30) and optionally using a Threshold Table. As a first step, one or more personal features are being extracted from the Personal Detail Record (30). As a non limiting example we can refer to the address of the user. Using searchable data bases, such as those available via the Internet with an HTTP/HTTPS interface, it is possible to extract qualification data items pertaining to said one or more personal features.

Non limiting examples of such extracted qualification data items are:

(a) The value of the house in which the user resides.

(b) The potential rent of the house in which the user resides

(c) The schools level of the neighborhood the user resides

(d) The user education level

(e) The number of connections the user has

(f) Work history of the user.

Using said qualification data items, any combination (e.g. linear and/or non linear and/or statistical) of them and optionally threshold levels, can be used to create an estimation of a score vector, comprising at least one score element, such as (non limiting examples):

(a) user financial wealth

(b) user personal employment potential.

Referring to the above non limiting example of the address of the user, a simple computerized Web based query can find the estimated value of the house in which the user lives. In case the estimated value of the house in not directly retrievable by such a query, the house estimated value can be derived e.g. by sale prices of similar houses in its vicinity, or alternatively considering the price trends in the area as function of time. Another simple Web based query can check whether the user owns that house or not. Both tests are described in the following paragraphs. In case the user owns the house, then a simple calculation can determine an estimation of the house net contribution to the user equity (deducting any standing debt). On the other hand if the user rents the house, those Web sites can give a good estimate of the renting cost which may also provide an indication relating to the user's financial status. A similar Web query may additionally find the schools assigned to address of the user, and based on valuation levels, such as those provided by Great Schools.org, can provide an additional estimation of the socio economic level of the user's neighborhood. Additional queries may extract several statistical information items on the town of the user and extract statistical data such as income distribution and demographic distribution. Similarly we can retrieve the user work history and the user professional connections. Other personal data features that can be used are user name, user picture, user age and user gender

For providing at least some of the qualification data items it is possible to extract social media data that can be extracted in the public domain (as a non limiting example, Linkedin) that can supply more particular information on the user, such as the number of connections, current and past employments, titles, length of time, education level, etc.). Those are examples of “free” data. In some other embodiments, data acquired from paid databases can also be used.

The described above exemplary qualification data items (and/or other qualification data items) can be further utilized to estimate at least one computed data item based on any (e.g. linear and/or non linear and/or statistical) combination of one or more of those qualification data items. In addition, said qualification data items and/or computed data items can be assembled into a score vector, comprising one or more score elements, which categorizes user qualification into predefined subject matters, such as its financial wealth, personal employment potential, past financial credibility, etc using various (e.g. linear and/or non linear and/or statistical) combinations and normalizations methods as known in the art.

For example, one computed element might be an estimation of the user's monthly or yearly income. Other non limiting examples of said computed elements can be the user net financial value, the user education level, estimation of the socio-economic level of the user, the user personal employment potential, etc. In addition, image analysis of the user's picture can supply some socio-economic data on the user.

In addition, the fusion of all those data elements can be used to classify the user to a class based on the Threshold Table. In one embodiment, each class has a minimum threshold per each computed data item, and in order to belong to a class the computed items of the user must be above those minimum threshold for those said computed data items. As a non limiting more detailed example, a user is found to live in a house worth $500K (and the median value house in his county is $400K), and he owns it, and has more than 20 years of employment in Fortune 1000 companies, and has a graduate degree. Based on that qualification data items and computed items, the user might be classified to the top level class. In contrast, take a user that lives in a $70 k house (where the median value in his county is $150K), and he rents, and has been on and off in low paying jobs. Based on that qualification data items and computed items, the user might be classified at a very low class.

The following is a description of a method to compute the computed data item of the value of the user's house: Several web sites, such as, but not limited to, Yahoo Real Estate, Zillow, Movoto, Realtor.com, Trulia, MSN Real Estate, Homes.com, AOL Real Estate, Rent.com, ZipRealty, MyNewPlace, LoopNet, Apartment Guide, Re/Max Real Estate, Apartments.com, Welchet.com, Redfin, HomeFinder, Listingbook Services, Rentals.com, ForRent.com can provide the current value of a house based on its address, and also the current rent.

The following is a description of a method to estimate the computed data item that determines whether the user owns the house he resides in or rents it: Most counties in the United States supply tax data information on all the dwellings in the county, based on the given address. Using the address (town and street name), it is possible to figure the county. Then use the address to retrieve from the relevant county web site, the owner and amount of tax for that dwelling. If the user name matches the house ownership name, then the user also owns that house. Otherwise, he is renting it.

In addition, biometric extraction modules (101-155) might be used as well for producing one or more qualification data items, which might be fused with other qualification data items. As a non limiting example, user emotional state as extracted by a biometric extraction module can be combined with e.g. user past financial transaction credibility to produce a fused value of the user credibility. As another non limiting example, the user biometrically extracted age, can be utilized as a factor in evaluating its financial user personal employment potential.

In yet another embodiment, the described above qualification data items and/or classification of a user into a predefined class, might be utilized to determine products and/or services to be offered to the user. As a an example, a user evaluated into a high financial wealth class and resides in a house which is nearby the sea, can be offered to buy a yacht, while a user renting a house might be offered with alternative renting options in the vicinity of that house.

The phrase “Interactive Voice Response (IVR) session as used herein may encompass an audio based call between a computer plugged into a phone system and a person who receive a phone call. A voice session may include transmission of analog and/or digital data, and may enable transfer of session data, audio data, and/or other relevant data. The phrase “biometric” as used herein may encompass the act of authentication a person by one of his physical characteristics. The phrase “data terminal” as used herein may encompass any output device, display system, processing unit, computing terminal, personal computer, network computer, mobile communications device that may be used for implementing a voice and/or videoconference and/or data collaboration session.

It will be appreciated by persons skilled in the art that the present invention is not limited by what has been particularly shown and described hereinabove. Alternate embodiments are contemplated which fall within the scope of the invention.

What is claimed is:

1. A method for qualifying a user comprising:
receiving a personal details record of said user;
extracting at least one personal feature out of said personal details record;
based on said at least one personal feature, extracting at least one qualification data item from at least one public domain Internet site, by matching said at least one feature in at least one public domain Internet site to said at least one personal feature; and
using said at least one qualification data item to create an estimation of at least one of:
(a) user financial wealth or
(b) user personal employment potential.

2. The method of claim 1, wherein said at least one personal feature comprising at least one of:
(a) user address,
(b) user name,
(c) user picture,
(d) user age, or
(e) user gender.

3. The method of claim 1, wherein said at least one qualification data item comprising at least one of:
(a) the value of the house in which the user resides,
(b) the potential rent of the house in which the user resides,
(c) the schools level of the neighborhood the user resides,
(d) the user education level,
(e) the number of connections the user has, or
(f) the work history of the user.

4. The method of claim 1, further comprising an estimation of at least one computed data item based on a statistical combination of one or more of the qualification data items.

5. The method of claim 4, wherein said at least one computed data item is
(1) estimation of user financial value,
(2) estimation of user monthly and annual salary,
(3) estimation of the socio-economic level of the user, or
(4) estimation of the user personal employment potential.

6. The method of claim 4, further comprising classifying the user to a class based on a threshold table and using at least one of computed data items where each class has a minimum threshold per each computed data item, and in order to belong to a class the computed items of the user must be above those minimum thresholds for those said computed data items.
